(19) United States
(12) Patent Application Publication
(10) Pub. No.: US 2026/0166351 A1
(43) Pub. Date: Jun. 18, 2026

(54) SPARK ARRESTOR DEVICE FOR REDUCING UTILITY POLE IGNITION EVENTS

(71) Applicants: Michael McGrade, Windsor, CT (US); Keegan O'Dell, Windsor, CT (US)

(72) Inventors: Michael McGrade, Windsor, CT (US); Keegan O'Dell, Windsor, CT (US)

(21) Appl. No.: 19/421,997

(22) Filed: Dec. 16, 2025

Related U.S. Application Data
(60) Provisional application No. 63/734,650, filed on Dec. 16, 2024.

(51) Int. Cl. A62C 2/06; A62C 3/16; H02G 7/00

(52) U.S. Cl. CPC A62C 2/06; A62C 3/16; H02G 7/00

(57) ABSTRACT

A spark arrestor device for reducing ignition events which may occur in the vicinity of a utility pole, where the spark arrestor device is formed as an attachment which is centered on the utility pole and positioned at a height above the ground. The spark arrestor device may be circular, and may be formed as a one-piece disk or may alternatively be formed as a disk having multiple constituent elements which together make up the overall disk. The spark arrestor device may be fixed in place when attached to the utility pole, or alternatively, the spark arrestor device may be made of one or more movable pieces that may be moved into position relative to the utility pole.

### CROSS-REFERENCE TO RELATED APPLICATION

This application claims the benefit of U.S. Provisional Patent Application Ser. No. 63/734,650, filed Dec. 16, 2024, which is herein incorporated by reference in its entirety.

### FIELD OF THE INVENTION

The present invention generally relates to the field of safety devices, and more particularly relates to a device for reducing ignition events which may occur in the vicinity of a utility pole, such as an electric utility pole.

### BACKGROUND OF THE INVENTION

Utility poles, such as electric utility poles, are used to support various types of cabling and other infrastructure as the cabling/infrastructure traverses great distances. Oftentimes, the cabling/infrastructure is used to transmit high voltages, resulting in occasional electrical sparks which are generated in the vicinity of the utility pole, as it is in this region where there may be exposed conductors or connectors. Also, flying animals or other debris may cause electrical sparks to be generated or conducted to nearby structures and areas.

To reduce the deleterious consequences of such electrical sparks, one approach is to clear vegetation or other potentially combustible or flammable material from an area adjacent to each utility pole. For example, one approach may be to clear vegetation in a circular region centered around the utility pole, where the circular region may have a radius of 20 feet. This approach is manually labor intensive and requires a significant investment in time and resources, and may also cause conflict with adjacent landowners who may oppose such clearing efforts. Also, in view of the fact that vegetation will likely return to the cleared area, such a vegetation clearing approach requires commitment of continued resources since the same areas may need to be frequently cleared since a single clearing will likely be insufficient as a permanent risk mitigation measure.

### SUMMARY OF THE INVENTION

In an embodiment, the present invention is directed to a spark arrestor device for reducing ignition events which may occur in the vicinity of a utility pole, where the spark arrestor device is formed as an attachment which is centered on the utility pole and positioned at a height above the ground. In an embodiment, the spark arrestor device may be circular or polygonal, and may be formed as a one-piece disk or may alternatively be formed as a disk having multiple constituent elements which together make up the overall disk. In certain embodiments, the spark arrestor device may be fixed in place when attached to the utility pole, or alternatively, the spark arrestor device may be made of one or more movable pieces that may be moved into position relative to the utility pole.

In an alternative embodiment, the present invention is directed to a spark arrestor device for reducing ignition events which may occur in the vicinity of a utility pole, where the spark arrestor device is formed as a basket which is positioned on or near the utility pole at a height above the ground, such that the structures or areas that may potentially cause unwanted sparks are positioned partially or fully within the basket structure so as to absorb or mitigate any potential spark.

In yet another alternative embodiment, the present invention is directed to a spark arrestor device for reducing ignition events which may occur in the vicinity of a utility pole, where the spark arrestor device is formed as a closure type device (e.g., utilizing snap closures) for completely encapsulating or surrounding any structures or areas on or around the utility pole that may potentially cause unwanted sparks.

### DESCRIPTION OF DRAWINGS

FIG. 1 is an illustration of a spark arrestor device according to a first embodiment of the present invention and having rigid moveable plates and a rigid fixed plate, showing the device mounted on a utility pole;

FIG. 2 is an illustration of a spark arrestor device according to a first embodiment of the present invention and having rigid moveable plates and a rigid fixed plate with a ridge, showing the device mounted on a utility pole;

FIG. 3 is an illustration of a spark arrestor device according to a first embodiment of the present invention and having rigid moveable plates and a rigid fixed plate with a pole sleeve;

FIG. 4 is an illustration of a spark arrestor device according to a second embodiment of the present invention and having rigid moveable plates and an elevated fixed deflection plate, showing the device mounted on a utility pole;

FIG. 5 is an illustration of a spark arrestor device according to a second embodiment of the present invention as shown in FIG. 4 and having rigid moveable plates and an elevated fixed deflection plate in a collapsed state, showing the device mounted on a utility pole;

FIG. 6 is an illustration of a spark arrestor device according to a third embodiment of the present invention and having a flexible circular shape, showing the device mounted on a utility pole;

FIG. 7 is an illustration of a spark arrestor device according to a third embodiment of the present invention as shown in FIG. 6 and having a flexible circular shape in a collapsed state, showing the device mounted on a utility pole;

FIG. 8 is an illustration of a spark arrestor device according to a fourth embodiment of the present invention and having a basket shape, showing the device mounted on a utility pole;

FIG. 9 is a side view illustration of a spark arrestor device according to a fourth embodiment of the present invention as shown in FIG. 8;

FIGS. 10a-10f are a series of illustrations showing the expansion states of the spark arrestor device of FIG. 1;

FIG. 11 is an illustration of a pole sleeve;

FIG. 12 is an illustration of a first embodiment of a pole collar;

FIG. 13 is a cross-sectional view of the pole collar of FIG. 12, showing the collar mounted on a utility pole;

FIG. 14 is an illustration of a second embodiment of a pole collar with vertical bearings;

FIG. 15 is a cross-sectional view of the pole collar of FIG. 14.

FIG. 16 is an upper perspective view of a spark arrestor device with mounting bracket assembly according to a fifth embodiment of the present invention, showing the device secured via the mounting bracket assembly to a utility pole;

FIG. 17 is a lower perspective view of the spark arrestor device with mounting bracket assembly of FIG. 16;

FIG. 18 is separate perspective view of the complete assembly of the spark arrestor device with mounting bracket assembly of FIG. 16;

FIG. 19 is an upper perspective view of the spark arrestor device portion of FIG. 16, showing the arrangement of a static petal and rotating petals;

FIG. 20A is a plan view of a static petal, and FIG. 20B is a cross-sectional view of the static petal of FIG. 20A;

FIG. 21A is an upper perspective view of a portion of a static petal, illustrating a further embodiment in which a vertical lip is provided on the radial edges of the static petal, and FIG. 21B is an enlarged lower perspective view of the static petal portion of FIG. 21A, detailing the vertical lip according to the further embodiment;

FIG. 22A is a plan view of the rotating petals, and FIG. 22B is a cross-sectional view of one of the rotating petals of FIG. 22A;

FIG. 23 is a perspective view of the mounting bracket assembly;

FIG. 24 is an exploded perspective view of the mounting bracket assembly of FIG. 23;

FIG. 25 is a separate perspective view of a pivot arm component of the mounting bracket assembly of FIG. 24; and

FIG. 26 is separate perspective view of the static petal mounting bracket component of the mounting bracket assembly of FIG. 24.

### DETAILED DESCRIPTION OF THE INVENTION

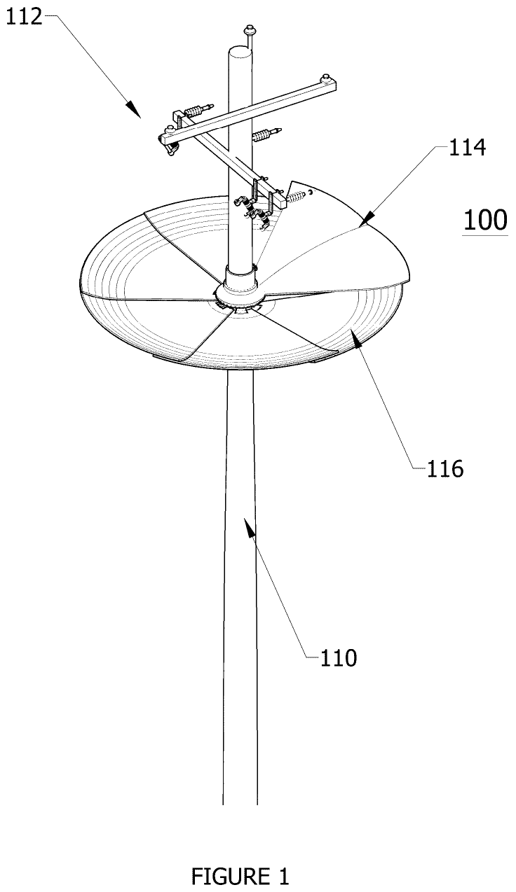

Referring now to FIG. 1, therein is illustrated a spark arrestor device 100 in accordance with a first embodiment of the present invention. The spark arrestor device 100 is intended for attachment to a utility pole 110. The spark arrestor device 100 is generally positioned above the ground, for example, at an appropriate height, which may range from as little as a few feet to 50 feet or more, depending on the application. The spark arrestor device 100 may be moveable along an axis of the utility pole 110, such that it may be positioned at different heights, or so that its positioned height may be changed as the circumstances warrant. The spark arrestor device 100 is positioned to be in the vicinity of potentially spark generating devices 112 and is positioned at a relative distance to spark generating devices 112 so as to optimally intercept any potential sparks that may be generated.

The spark arresting device 110 includes a fixed plate 114 which may be formed as a rigid plate. The spark arresting device 110 is preferably formed from an electrically nonconductive material, such as polymer, polyethylene, high grade rubber, or plastic. The spark arresting device may shed water or other accumulated debris by having portions being permeable to water or utilizing slits to allow water or other debris to pass through. The remainder of the spark arrestor device 110 may be made of generally pie-shaped moveable portions 116 which may pivot or rotate about the axis of the utility pole 110 so that they may be brought under the fixed plate 114.

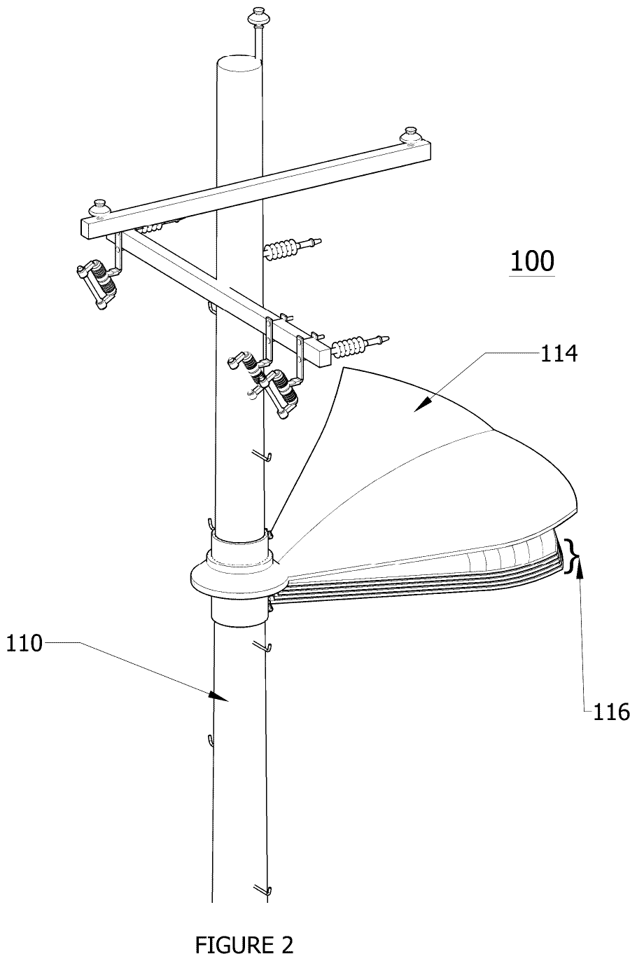

FIG. 2 illustrates the spark arrestor device 110 when the moveable portions 116 are brought under the fixed plate 114. The spark arrestor device 110 may be constructed with any number of moveable portions 116, for example, five portions, each spanning 60 degrees of a circle, as well as the fixed plate 114, which might span 60 degrees, such that the combination of moveable portions 116 and the fixed plate together span 360 degrees of a full circle. In other embodiments the moveable plate portions 116 and the fixed plate 114 may span differing numbers of degrees, such that portions of the plates overlap when fully expanded.

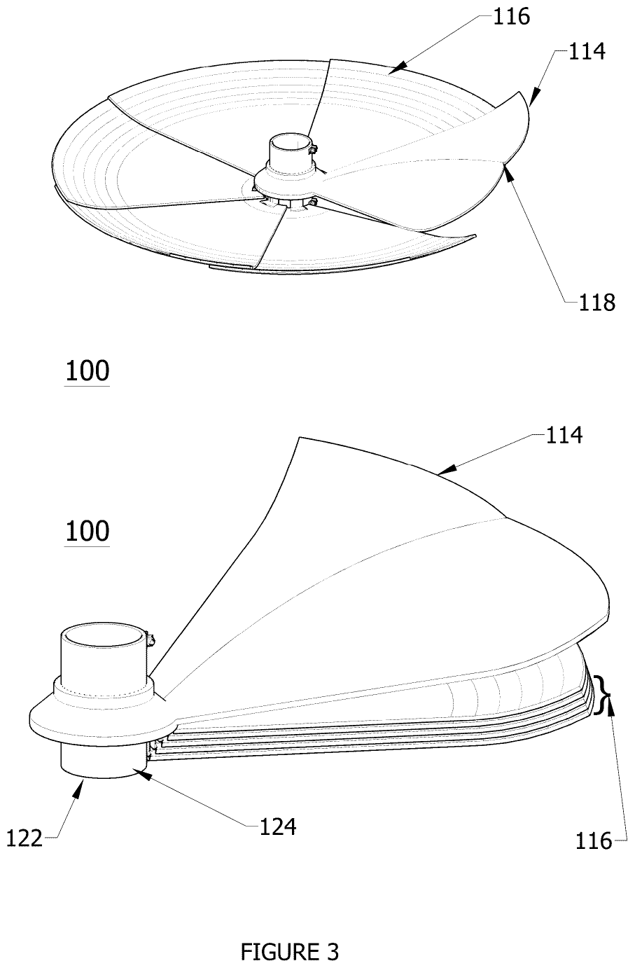

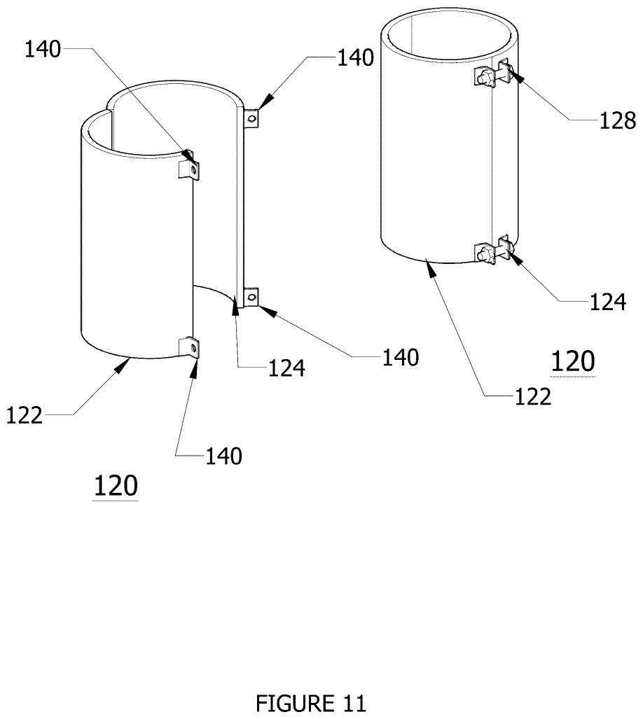

FIG. 3 illustrates a spark arrestor device 100 according to a first embodiment of the present invention and having moveable rigid plates 116 and a rigid fixed plate 114 with a pole sleeve. Further, the fixed rigid plate 114 includes a ridge 118 to create a bowed or convex shape so that water or other debris may more easily slide off the fixed rigid plate 114. The spark arrestor device 100 illustrated in FIG. 3 includes a generally tubular sleeve 120 which is concentric with the utility pole 110 it is to be attached to. The sleeve 120 may be constructed so as to have two hingedly mated halves 122, 124 to allow opening and closing of the sleeve 120 in order to place it around the utility pole 110, as illustrated and described in connection with FIG. 11 below.

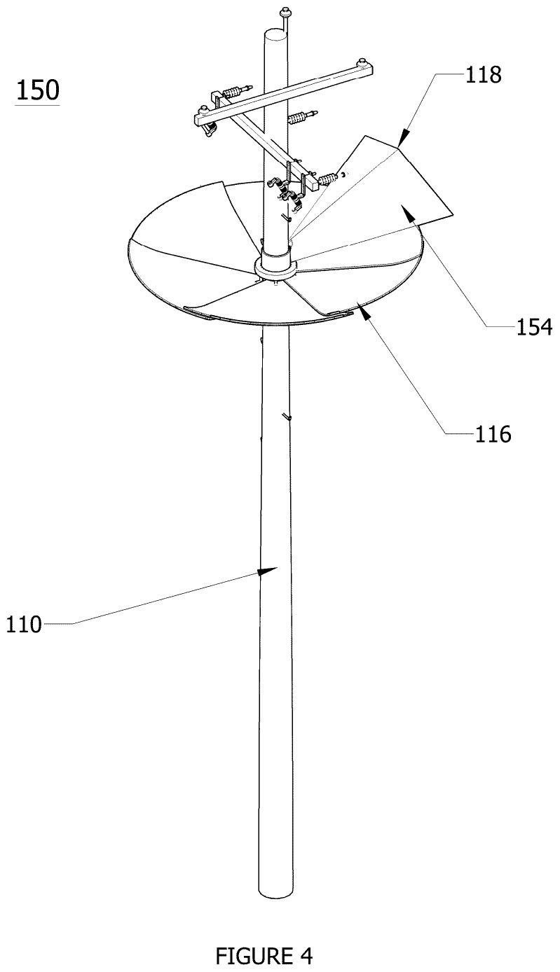

Referring now to FIG. 4, therein is illustrated a spark arrestor device 150 according to a second embodiment of the present invention and having moveable rigid plates 116 and a fixed elevated deflection plate 154. This second embodiment spark arrestor device 150 differs from the first embodiment spark arrestor device 100 in that the second embodiment spark arrestor device 150 includes a number of moveable rigid plates 116 which may be pivoted to together make up a complete circular (or polygonal) structure surrounding utility pole 110. Additionally, the fixed deflection plate 154 is positioned so as to be elevated with respect to moveable plates 116.

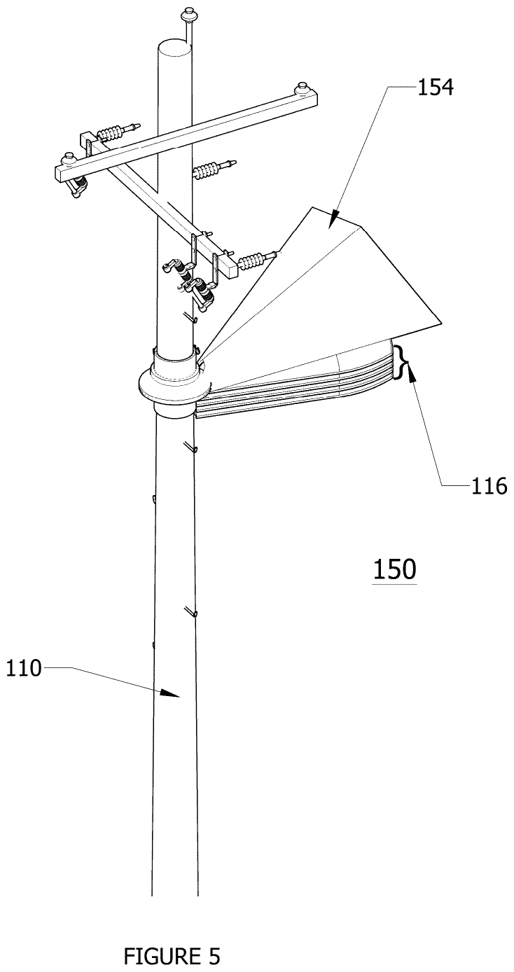

Referring now to FIG. 5, therein is illustrated a spark arrestor device 150 according to a second embodiment and having fixed plate 154, and further showing moveable plates 116 in a nested, collapsed configuration wherein they are all moved to be positioned under fixed plate 154.

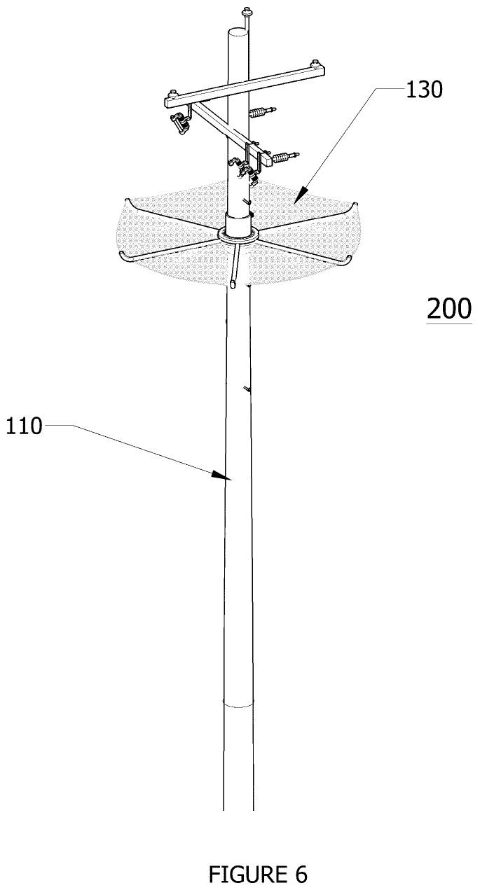

Referring now to FIG. 6, therein is illustrated a third embodiment of a spark arrestor device 200 having a number of pie-shaped elements 130 which together form a complete circular- or polygon-shaped spark arrestor device 200 positioned around utility pole 110. In this alternative embodiment, the spark arrestor device 200 is constructed of a flexible material, such as a mesh material. Additionally, in certain embodiments, the flexible material spark arrestor device 200 may be permeable to water or other debris. This permeability may be achieved by utilizing mesh material which has sufficiently sized openings so as to allow water to pass through. The flexible spark arrestor device 200 may be constructed from fiberglass composite material or similar material which is generally lightweight but having sufficient structural shape and/or rigidity.

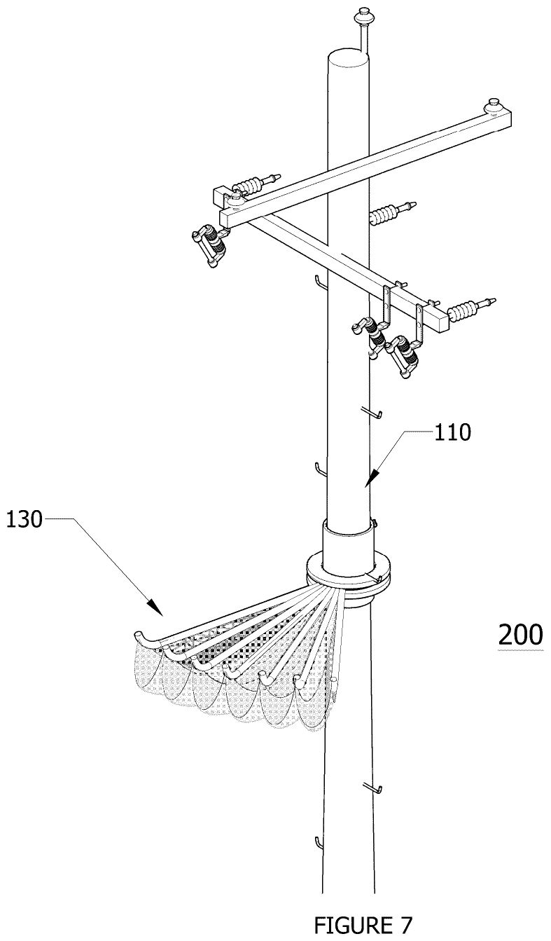

Referring now to FIG. 7, therein is illustrated the flexible material spark arrestor 200 of FIG. 6, but in a collapsed or open configuration wherein the constituent elements 130 are gathered together in a close configuration.

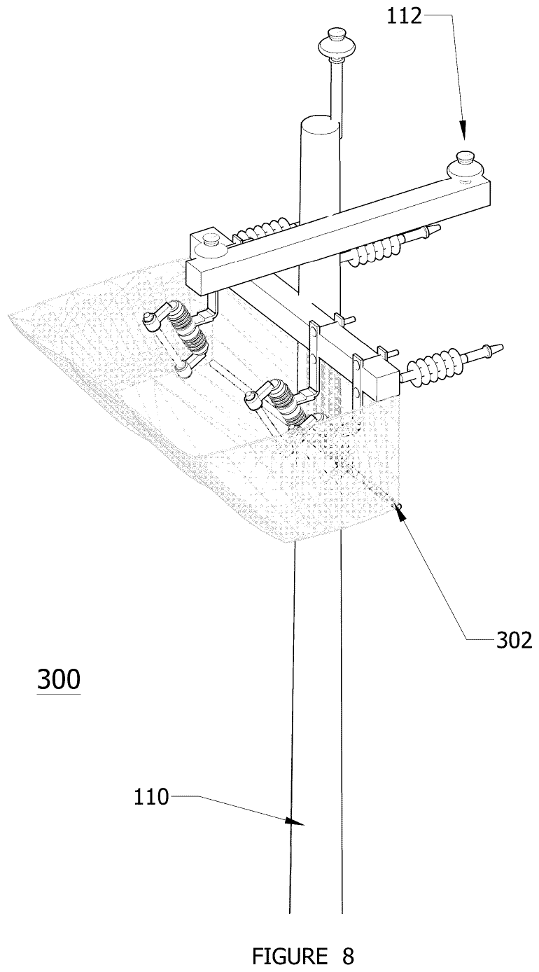

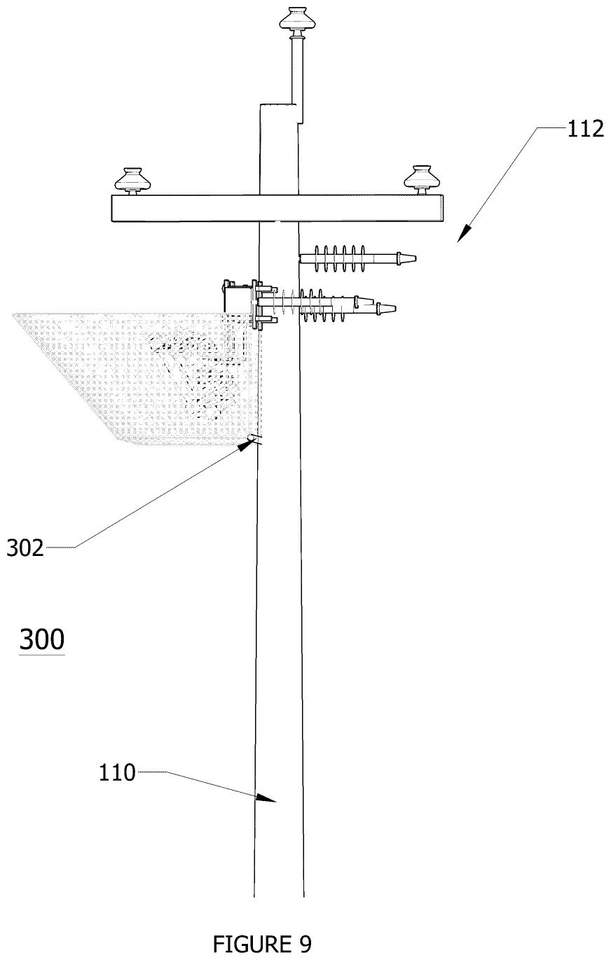

FIGS. 8 and 9 illustrate a spark arrestor device 300 according to a fourth alternative embodiment of the present invention, and having a deep basket shape. The basket 300 is provided with one or more hinges 302 to allow opening of the basket for installation or cleaning purposes. The basket-shaped spark arrestor device 300 is sized and positioned so as to surround, at least partially, the potential spark generating devices 112 which may be located on the utility pole 110. In this way, the basket-shaped spark arrestor device 300 is operative to intercept any potential sparks which may be generated by the devices 112 before they hit the ground area surrounding the utility pole 110. FIG. 9 illustrates a side view of the basket-shaped spark arrestor device 300, showing the one or more hinges 302 which may be used to open the basket-shaped spark arrestor device 300. The basket-shaped spark arrestor device 300 may be constructed from fiberglass composite material or similar material which is generally lightweight but having sufficient structural shape and/or rigidity. The spark arrestor device 300 may be attached to the utility pole using nuts and bolts, screws, or any attachment mechanism effective for the purpose.

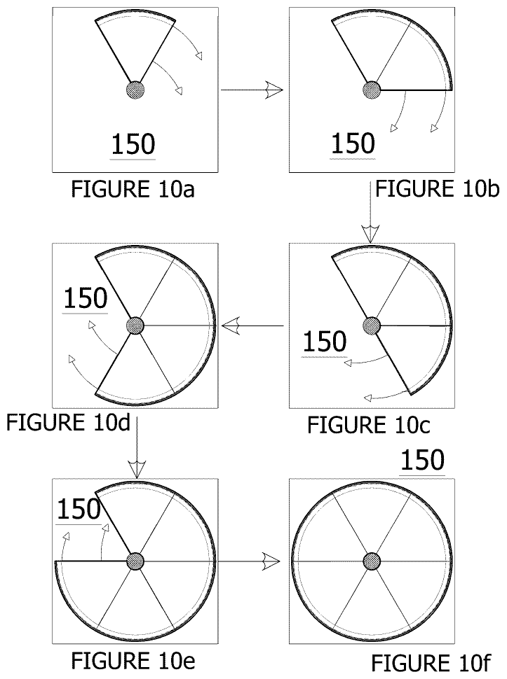

FIGS. 10a-10f are a series of illustrations showing the expansion states of the spark arrestor device 100 of FIG. 4. The series of figures show how a six-piece spark arrestor device 150 may unfold sequentially from a collapsed state in which all six pieces are positioned under each other (FIG. 10a), to an expanded state in which the constituent pieces sequentially pivot circumferentially so as to form a complete circle (FIG. 10f). Each piece of the spark arrestor device 150 may be positioned in a slightly different horizontal plane so as to allow easy rotation. Alternatively, each piece of the spark arrestor device 150 may be positioned in the same plane as one or more other pieces of the spark arrestor device 150. Also, one or more of the individual pieces may be provided a positioning mechanism to allow proper relative positioning with respect to the other pieces of the spark arrestor device 150 so that there are no gaps when the pieces are moved so as to form the complete circle of the spark arrestor device 150.

Referring now to FIG. 11, therein is illustrated a pole sleeve 120 having mating pole sleeve halves 122 and 124. The pole sleeve halves 122 and 124 may be hingedly joined together to allow opening for maintenance or for insertion or attachment of the spark arrestor device 100 to the utility pole 110. The pole sleeve halves 122, 124 may be joined or secured together using a combination of nuts and bolts 128 engaging outward extending flanges 140 formed on each pole sleeve half 122, 124. The pole sleeve halves 122, 124 may also be secured together by any other clasping mechanism effective for that purpose.

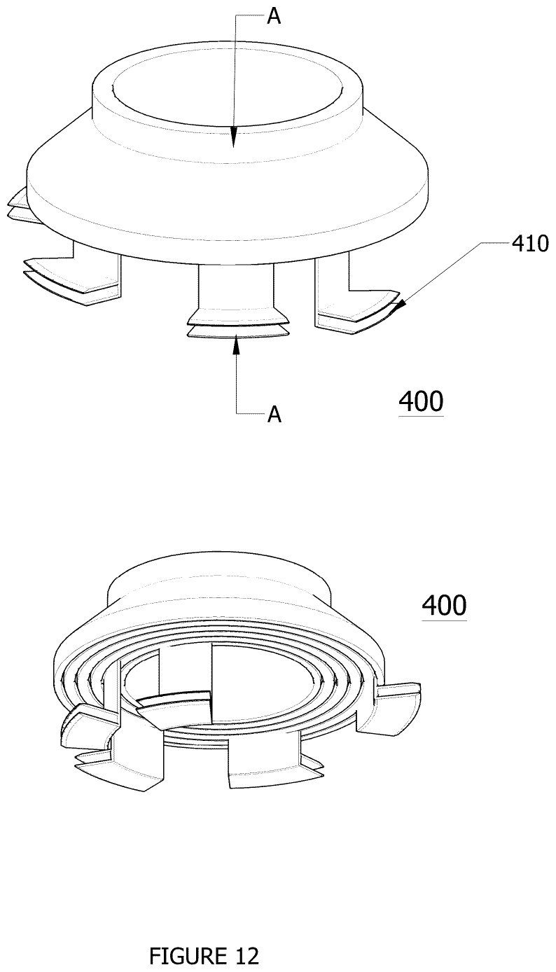

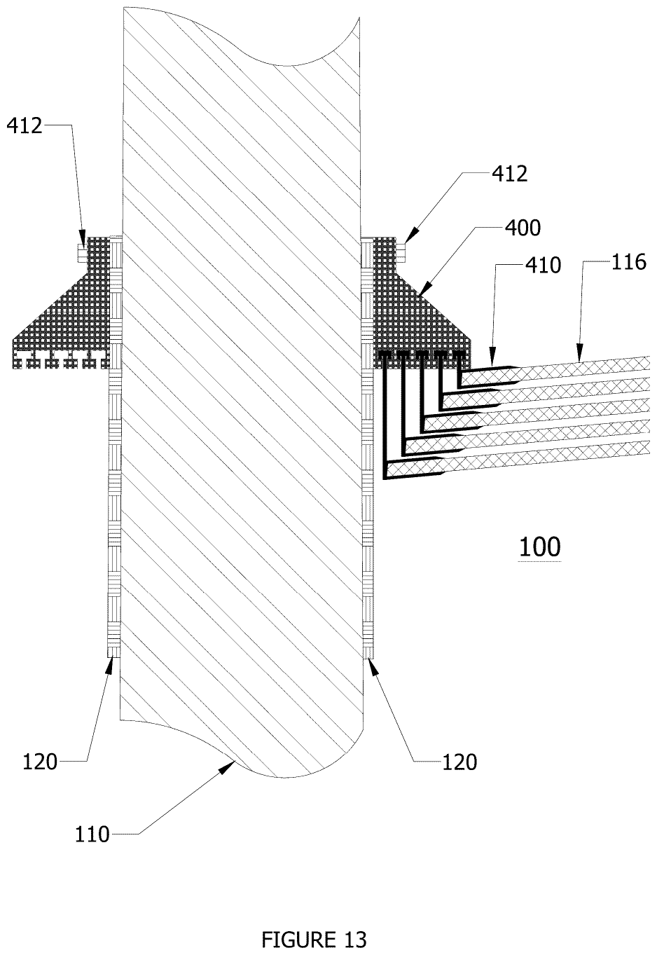

Referring now to FIG. 12, therein is illustrated a pole collar 400 with radially outwardly extending arms 410 for engaging and supporting plates 116 (see FIG. 13). The diameter of the pole collar 400 may be adjustable so as to accommodate different sized poles. The pole collar 400 is constructed so as to carry the spark arrestor device 100 and allow attachment of the spark arrestor device 100 to the utility pole 110.

FIG. 13 is a cross-sectional illustration of pole collar 400 taken along the lines A-A in FIG. 12, and showing the attachment of pole collar 400 to utility pole 110 and also to plates 116. Specifically, as shown in FIG. 13, sleeve 120 is placed so as to surround utility pole 110, and is attached to utility pole 110 by way of bolts or other attachment devices. Collar 400 is then mated and joined to sleeve 120 by way of nuts/bolts 412. In this way, collar 400 may be configured to have radially outwardly extending arms 410 for engaging and supporting each of the plates 116. Each plate 116 may be received in a U-shaped recess formed at the distal end of each arm 410. Each plate 116 may be joined to its corresponding arm 410 using any number of attachment mechanisms, such as adhesive, mechanical attachment (e.g., nuts/bolts), and the like. As shown in FIG. 13, the arms 410 may be staggered or offset with respect to each other both in the vertical direction, as well as in the horizontal direction, to allow for free motion by each of the plates 116.

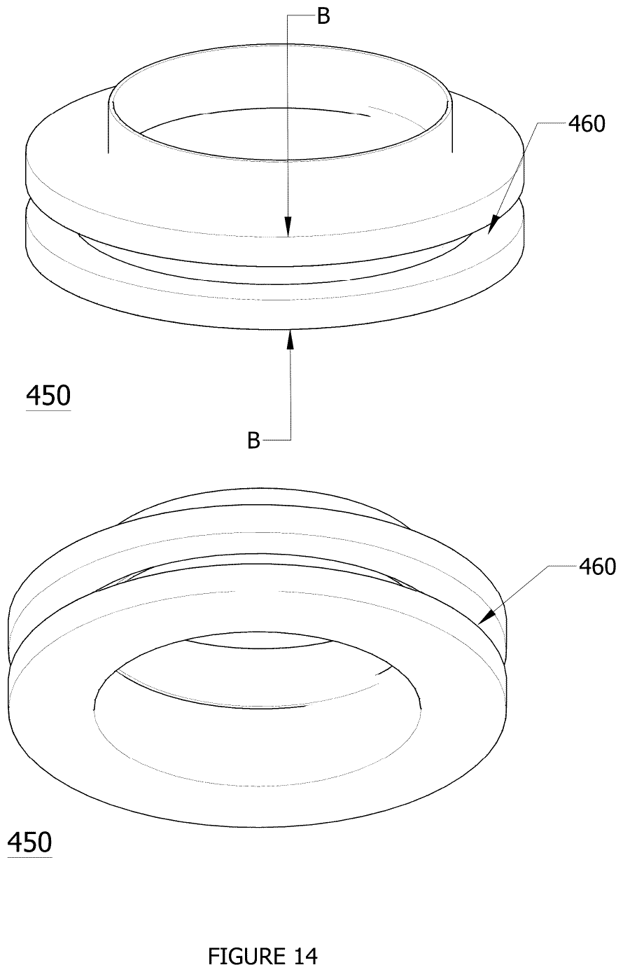

Referring now to FIG. 14, therein is illustrated a pole collar 450 utilizing vertical bearings for attachment to a spark arrestor device having a mesh type construction, such as spark arrestor device 200 illustrated in FIG. 6. The pole collar 450 is provided with a channel or recess 460 for receiving bearings attached to each of the plates which make up the spark arrestor device.

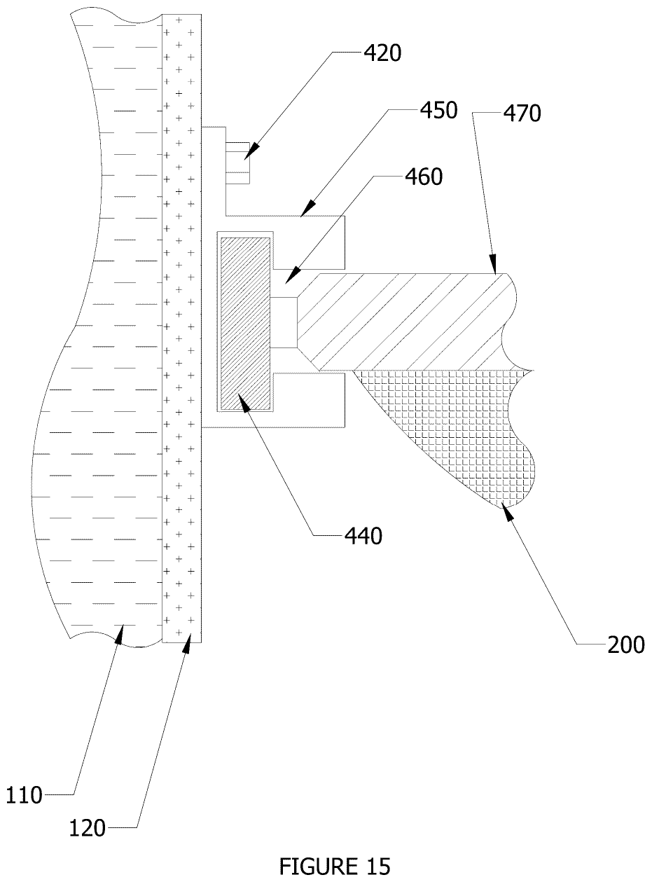

As shown in more detail in FIG. 15, therein is illustrated a cross-sectional illustration of the pole collar 450 of FIG. 14 taken along lines B-B. As shown in FIG. 15, sleeve 120 is positioned and secured around utility pole 110. Collar 450 is then secured to the sleeve 120, for example, by way of nuts/bolts 420 or similar attachment mechanisms. As further shown in FIG. 15, collar 450 includes a circumferential channel or groove 460 sized and shaped so as to receive a number of bearings 440, which each may be a vertically oriented bearing. In this way each bearing 440 may freely rotate in a circumferential direction around an axis of utility pole 110. Each bearing has attached to it a radially outwardly extending arm 470 to which is attached a portion of a spark arrestor device, such as mesh material 200. Alternatively, each radially outwardly extending arm 470 may be attached to a rigid plate 116 of a spark arrestor device. As each bearing 440 rotates around utility pole 110, its corresponding spark arrestor device portion (e.g., mesh material 200 or plate 116) may be moved in a circumferential direction around utility pole 110.

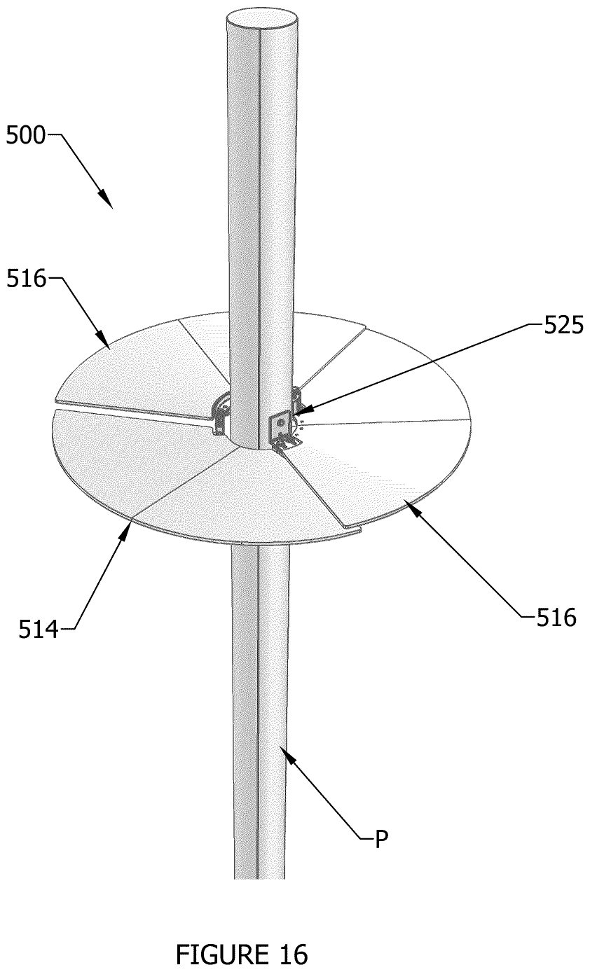

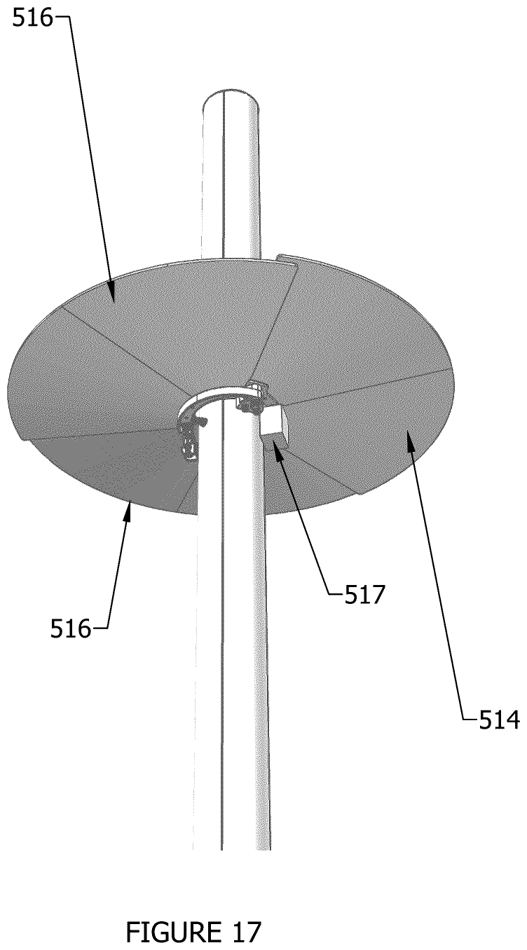

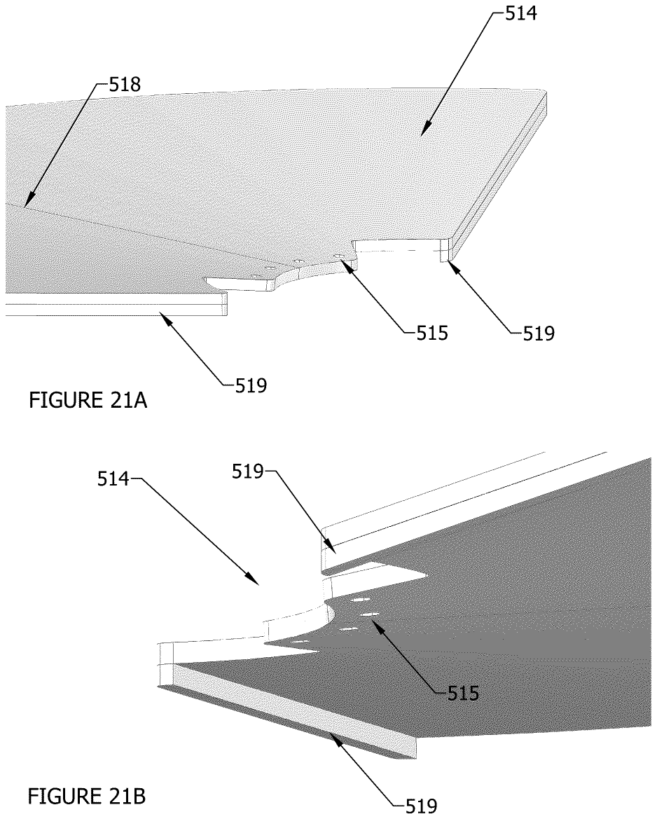

In a further embodiment as shown in FIGS. 16-25, a mounting bracket assembly 520 may be used instead of the above-described sleeve and collar combination to secure or mount the spark arrestor device 500 on a utility pole. FIGS. 16-17 are upper and lower perspective views that illustrate upper and lower portions of a mounting bracket assembly 520 used to mount a static petal 514 and rotating petals 516 to a utility pole P. The petals 514, 516 are preferably formed from an electrically nonconductive material, such as polymer, polyethylene, high grade rubber, or plastic. When pivoted together to surround the utility pole P, the petals 514, 516 preferably form a circular shape, as shown, but may also form a polygonal or other shape. The petals 514, 516 may be of any practical length and preferably have a radial length of a few feet, for example, 3 or 4 feet. As used herein, the term petal is interchangeable with plate, and generally denotes one of a plurality of roughly fan- or pie-shaped elements included in the spark arrestor device 500. As described in further detail below, the mounting bracket assembly 520 may include one or more pole mounting brackets 525 that may be attached to the utility pole using nuts and bolts, screws, or any attachment mechanism effective for the purpose. Also as described in detail below, the mounting bracket assembly 520 may have an articulating multi-level hinged structure that holds the petals at different elevations and that allows the rotating petals 516 to pivot or rotate so as to facilitate installation of the spark arrestor device 500 on a utility pole and to facilitate cleaning, access to pole top, work on facilities existing above the arrestor, and maintenance. The rotating petals 516 may also be pivoted above and below the static petal 514 to form a compact, collapsed configuration that requires less space for storage or transport. The multi-level hinged structure also permits the side edges of the petals to overlap partially when fully expanded to enhance rigidity of the spark arrester device 500. As described below, one or more of the petals 514, 516 may also be provided with one or more vertical lips (see FIGS. 21A, 21B) that protrude in an axial-direction and extend in a radial-direction, along one or both radial edges of the petal.

The rotating petals 516 may be pivoted or rotated manually by an operator. Alternatively, the rotating petals 516 may be pivoted or rotated by a motor 517 coupled to the petals 516 and attached to the mounting bracket assembly 520. In the embodiment shown in FIG. 17, the motor 517 is attached to the underside of the mounting bracket 520. The motor 517 may be operated remotely via a control system (not shown) that receives instructions from a remote control device (not shown) using, for example, infrared (IR) communication, Bluetooth® communication, WiFi communication, and/or radio frequency (RF) communication. The motor 517 and/or the remote control system may be configured to receive electrical power from a power source such as the service from a potential transformer on the utility pole, a battery, a solar power source, or other source effective for the purpose.

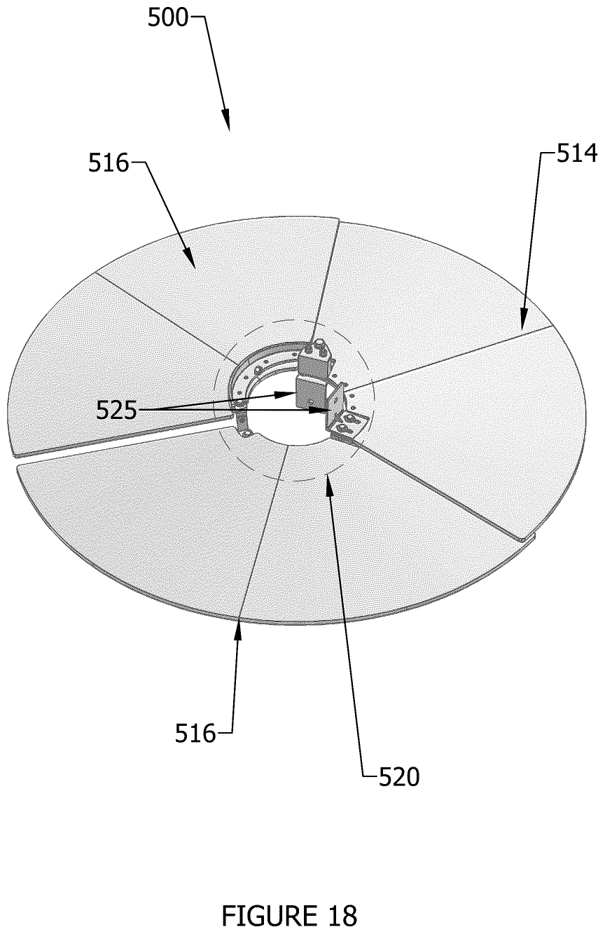

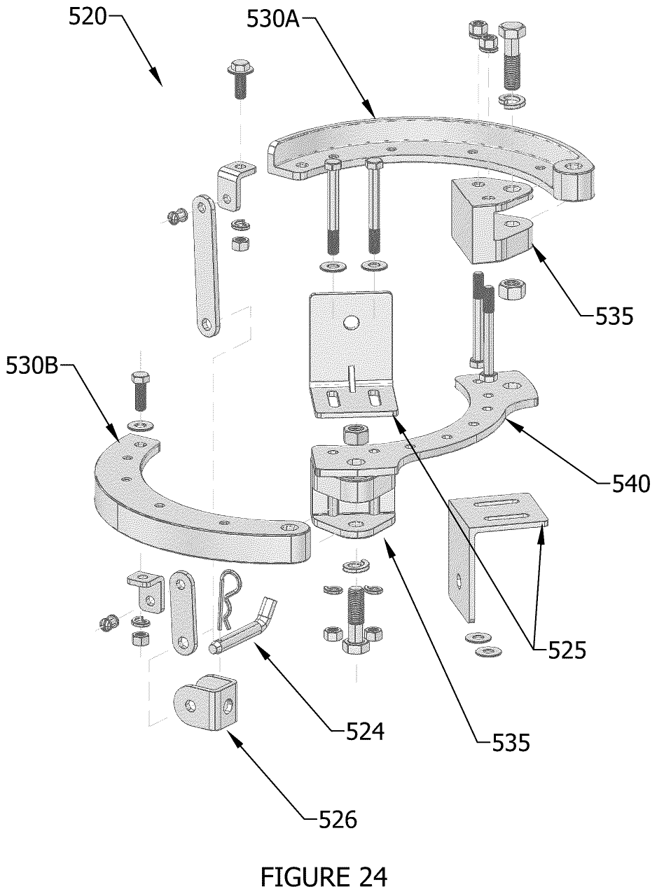

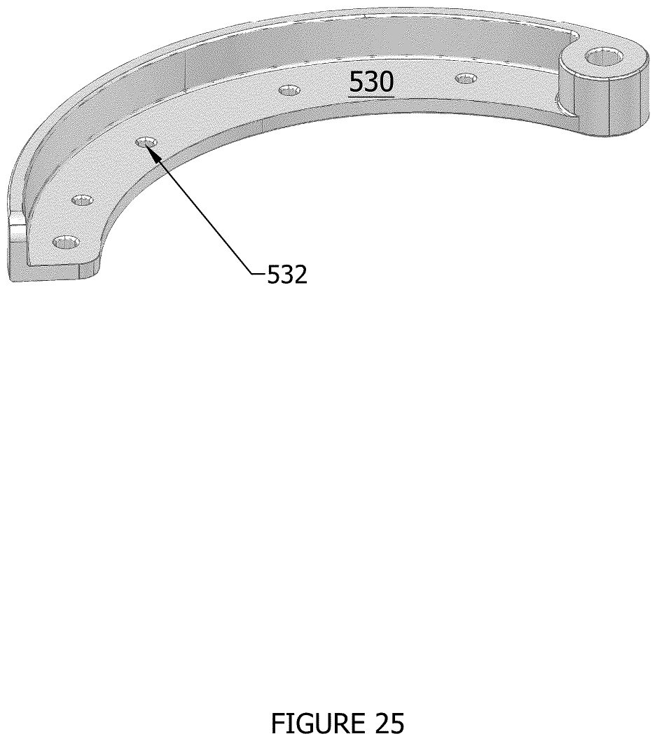

Referring now to FIG. 18, therein is illustrated an upper perspective view of the static petal 514 and rotating petals 516 attached to the mounting bracket assembly 520. As will be described in further detail below, the static petal 514 may be attached to a static petal mounting bracket 540 (see FIG. 25) and each rotating petal 516 may be attached to a pivot arm 530 (see FIG. 24) of the mounting bracket assembly 520. The petals 514, 516 may be attached to the respective petal mounting bracket 540 or pivot arm 530 by using nuts/bolts or other attachment mechanism effective for the purpose. Additional embodiments are conceived in which the petals 514, 516 are attached in groupings of two or more to each petal mounting bracket 540 or pivot arm 530.

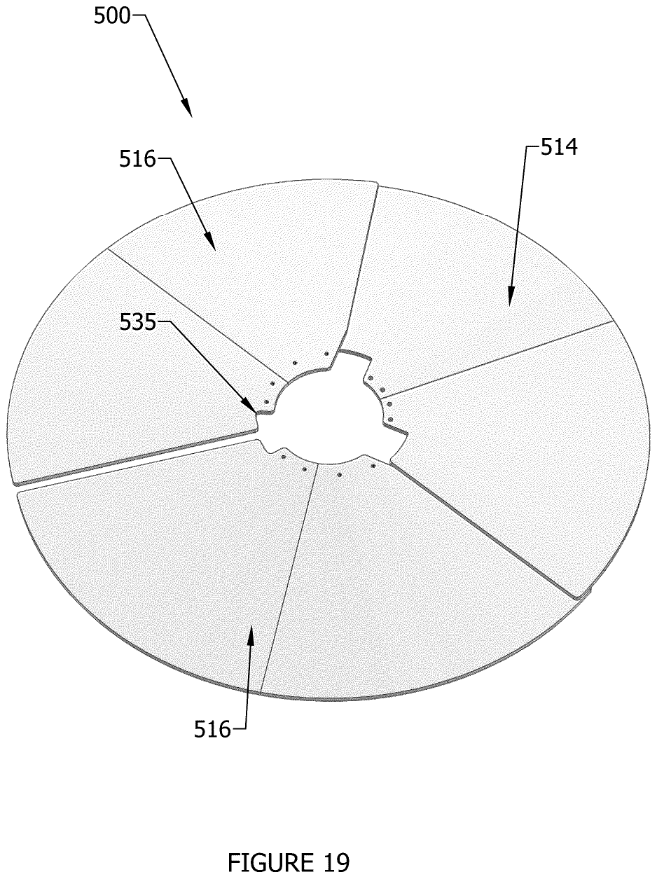

Referring now to FIG. 19, therein illustrated is an arrangement of the static petal 514 and rotating petals 516 of the spark arrestor device 500. Each petal 514, 516 is provided with holes 515 for attaching the petal to the corresponding pivot arm 530 or the static petal mounting bracket 540. Each petal 514, 516 is also provided, at one corner of its inner edge, with a notch 535 to accommodate a corresponding contour of the mounting bracket assembly 520.

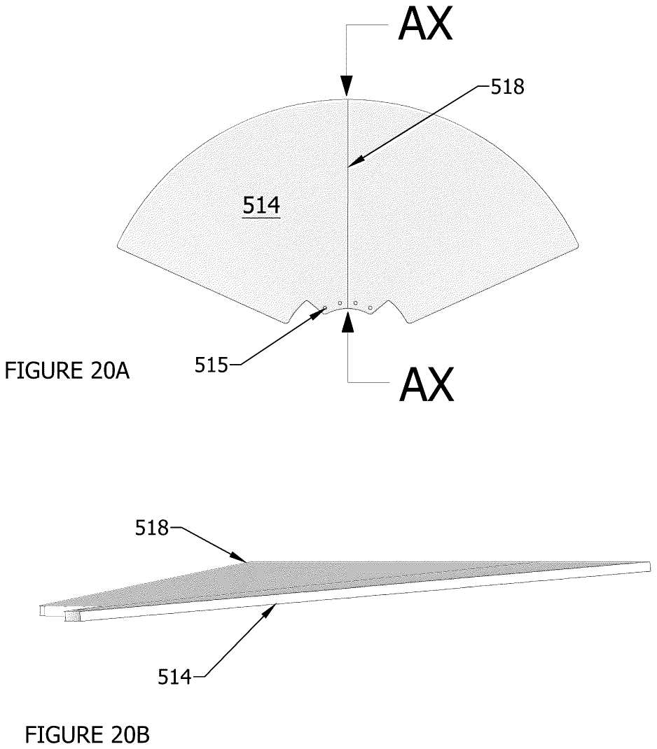

FIGS. 20A and 20B illustrate, respectively, a plan view and a cross-sectional view of the static petal 514. FIG. 20B is taken along lines AX-AX of FIG. 20A. The static petal 514 may include a ridge 518 to create a bowed or convex shape so that water or other debris may more easily slide off the static petal 514. The static petal 514 may be generally sloped downward such that when positioned on a pole, the petal's outer circumferential edge or end is vertically higher than its inner circumferential edge.

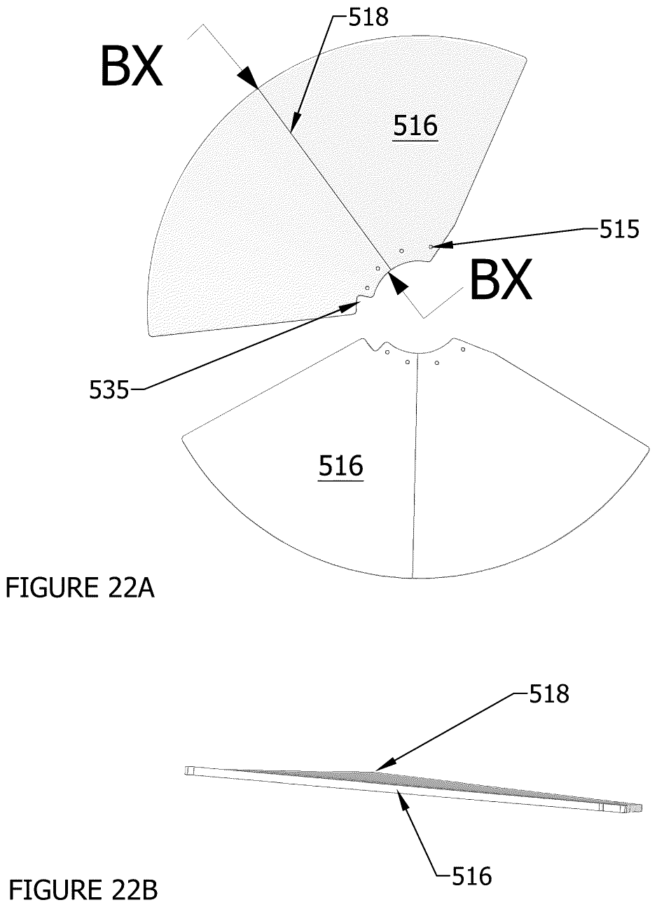

As shown in FIGS. 21A and 22B, the static petal 514 may also optionally be provided with a vertical lip 519 on one or both of its radial edges or ends which extend from the petal's inner circumferential end to its outer circumferential end. As shown in the figures, the vertical lip 519 may protrude in an axially downward direction and extend for the full length of the radial edge of the static petal 514, but other embodiments are contemplated in which the vertical lip 519 may protrude axially upward and/or extend for only a portion of the radial edge. Alternatively, one or more vertical lips 519, each lip 519 extending for only a portion of the radial edge and protruding upward, downward or in any combination thereof, may be disposed along a radial edge of the static petal 514. The vertical lip 519 help to guide and align the petals 514, 516 while pivoting or rotating. The vertical lip 519 may also function to clean or wipe debris from the petals 514, 516 as they contact the lip(s) 519 while pivoting or rotating. A further embodiment in which one or more vertical lips 519 are disposed on one or more rotating petals is also contemplated. The vertical lip 519 may be formed from the same electrically nonconductive material as the petal, and preferably is formed from a variation that is slightly more pliable than the material of the petal 514, 516 so as to enhance its cleaning/wiping performance and avoid damaging the petals 514, 516.

FIGS. 22A and 22B illustrate, respectively, a plan view and a cross-sectional view of the rotating petals 516. FIG. 22B is taken along lines BX-BX of FIG. 22B. Each rotating petal 516 may also include a ridge 518 to create a bowed or convex shape so that water or other debris may more easily slide off the rotating petal 516. The rotating petals 514 may be generally sloped downward such that when positioned on a pole, each rotating petal's outer circumferential edge is vertically higher than its inner circumferential edge.

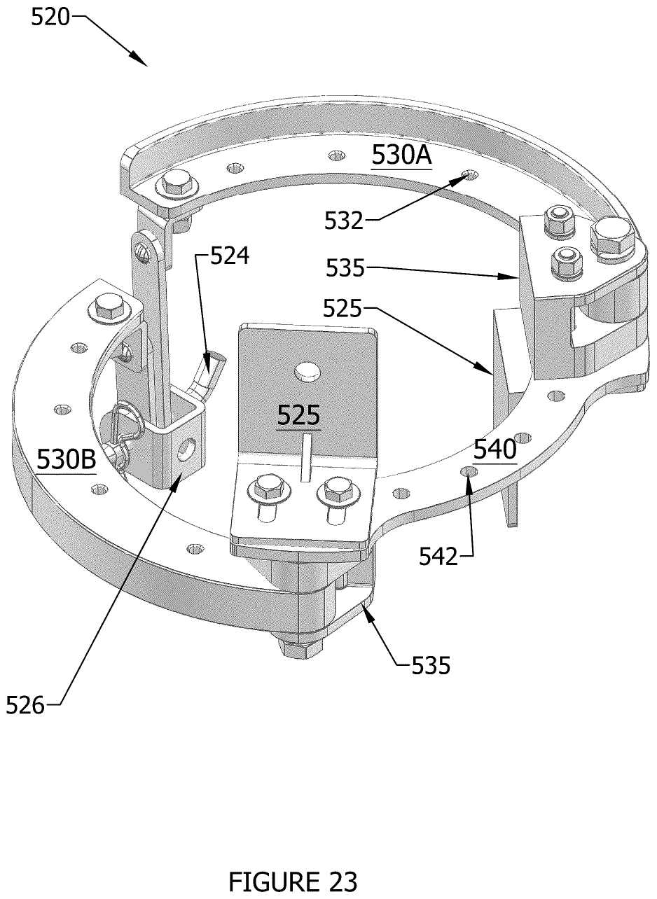

The mounting bracket assembly 520 is shown in detail in FIGS. 23-24. FIG. 23 shows the mounting bracket 520 in its complete assembled state and FIG. 24 shows an exploded view thereof. As can be seen, the mounting bracket assembly 520 is configured as a multi-level articulating bracket assembly that holds the various petals 514, 516 at different elevations. The embodiment shown includes an upper pivot arm 530A and a lower pivot arm 530B, with the static petal mounting bracket 540 disposed at an elevation between that of the pivot arms 530A, 530B. This multi-level articulating structure allows for mounting to utility poles of various diameters and accommodates petal plates 514, 516 of various sizes. As described above, additional advantages of this multi-level articulating structure include facilitated installation and cleaning/maintenance, a compact folded size for easier storage and transport, and enhanced rigidity when fully expanded due to an overlapping petal configuration. The mounting bracket assembly 520 includes pole mounting brackets 525 for securing both ends of the static petal mounting bracket 540 to a utility pole. Each end of the static petal mounting bracket 540 is pivotably coupled via a pivot bracket 535 to a pivot arm 530A, 530B. The pivot arms 530A, 530B are provided with rotating petal mounting holes 532 and the static petal mounting bracket 540 is provided with static petal mounting holes 542 for coupling to the respective petal 514, 516. The respective pivot arms 530A, 530B may be secured together by a locking means that may include, for example, a clevis pin 524, a clevis bracket 526, and a locking (cotter) pin. In embodiments that utilize a motor 517 to rotate the pivot arms 530A, 530B instead of the aforementioned locking means the intrinsic detent torque of the motor 517 will hold the pivot arms 530A, 530B in place.

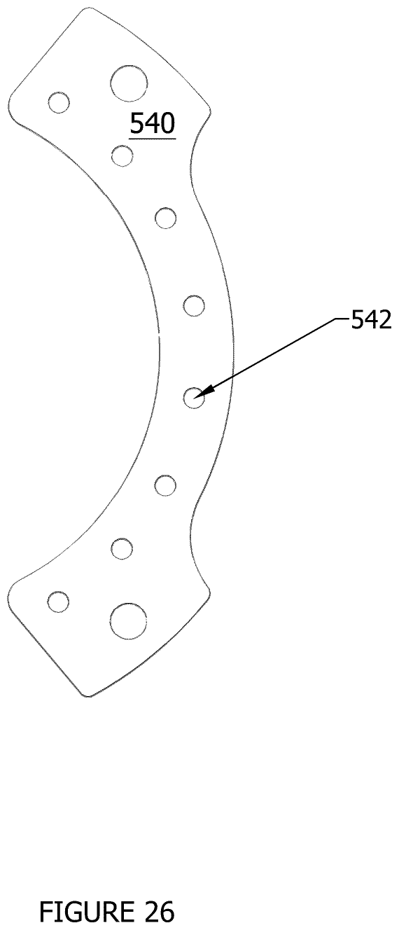

FIGS. 25 and 26 are detailed perspective views, respectively, of the pivot arm 530 and the static petal mounting bracket 540 of the mounting bracket assembly 520. As illustrated in FIG. 25, the pivot arm 530 is provided with mounting holes 532 for attachment to the inner circumferential edge of a corresponding rotating petal 516. Similarly, as shown in FIG. 26, each mounting bracket 540 is provided with mounting holes 542 for attachment to the inner circumferential edge of a corresponding static petal 514.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A device for reducing utility pole ignition events, comprising:
a plurality of petals, each petal having an inner circumferential end and an outer circumferential end, the plurality of petals configured to be arranged in a contiguous circular arrangement at their respective inner circumferential ends around a utility pole, the petals being formed of an electrically nonconductive material.

2. The device of claim 1, wherein the plurality of petals comprise a fixed petal and at least one moveable petal.

3. The device of claim 2, wherein the at least one moveable petal is vertically offset at its inner circumferential end with respect to the fixed petal and is operable to rotate and be positioned under the fixed petal.

4. The device of claim 1, wherein the plurality of petals comprise moveable petals.

5. The device of claim 4, wherein the moveable petals are vertically offset at their inner circumferential end with respect to each other and are operable to rotate and be positioned at respective different vertical positions.

6. The device of claim 1, wherein the electrically nonconductive material comprises a polymeric material, polyethylene, rubber, or plastic.

7. The device of claim 1, wherein at least one petal includes one or more slits.

8. The device of claim 1, wherein at least one petal comprises a mesh material.

9. The device of claim 1, wherein at least one petal comprises a downward lip extending from the inner circumferential end to the outer circumferential end of the petal.

10. The device of claim 9, wherein at least one petal comprises an upward lip extending from the inner circumferential end to the outer circumferential end of the petal.

11. The device of claim 1, wherein at least two petals are configured to overlap each other when arranged around the utility pole.

12. The device of claim 1, further comprising a generally tubular sleeve having two mating hinged portions and configured to be placed around the utility pole, the plurality of petals being further configured to be attached to the tubular sleeve in a radially outward direction.

13. The device of claim 1, further comprising a mounting bracket assembly configured to be attached to the utility pole, the mounting bracket assembly comprising a plurality of brackets corresponding to the plurality of petals, each bracket operable to attach to a petal at its corresponding inner circumferential end.

14. The device of claim 13, wherein the plurality of brackets are offset vertically with respect to each other so that the corresponding attached petals are positioned vertically offset with respect to each other.

15. The device of claim 1, further comprising a motor operable to move the plurality of petals.

16. The device of claim 15, further comprising a wireless control for operating the motor.

17. The device of claim 1, wherein the plurality of petals when arranged around the utility pole together form a substantially basket shaped structure.

18. The device of claim 1, wherein at least two petals are joined together along a radial direction extending from their respective inner circumferential ends to their respective outer circumferential ends.

19. The device of claim 1, wherein the plurality of petals are each substantially convex shaped.

20. The device of claim 1, wherein a dimension of each petal from its inner circumferential end to its outer circumferential end is in a range of between two and six feet.

21. A device for reducing utility pole ignition events, comprising:
a plurality of petals, each petal having an inner circumferential end and an outer circumferential end, the plurality of petals configured to be arranged in a contiguous circular arrangement at their respective inner circumferential ends around a utility pole, the petals being formed of an electrically nonconductive material;
wherein the plurality of petals comprise one or more moveable petals operable to rotate about the utility pole;
wherein the plurality of petals are dimensioned so that when they are arranged around the utility pole they provide a substantially continuous and gap-free structure of electrically nonconductive material centered about the utility pole.
